(19) United States
(12) Patent Application Publication
(10) Pub. No.: US 2002/0175012 A1
(43) Pub. Date: Nov. 28, 2002

(54) Control system of vehicle cruise device

(76) Inventor: Wen Jun Sun, Kaohsiung (TW)

Correspondence Address: STEVENS, DAVIS, MILLER & MOSHER, L.L.P., P. O. Box 34387, WASHINGTON, DC, 20043, US

(21) Appl. No.: 10/152,781

(22) Filed: May 23, 2002

(30) Foreign Application Priority Data
May 23, 2001 (TW) 90112728

(51) Int. Cl. B60K 31/04

(52) U.S. Cl. 180/179

(57) ABSTRACT

A control system is applied to a vehicle cruise device which is installed in a vehicle driven by an internal-combustion engine that has a speed control mechanism to control the vehicle speed. The control system includes a traveling signal input end, a command input end, a memory, a processor, and a control signal output end. The traveling signal input end is used for inputting the vehicle traveling signal into the control system. The command input end is connected to the command module for receiving the control command from the driver. The memory is used for storing the setting parameters of the control system. The processor is used for generating a control signal according to the control command, traveling signal, and setting parameters. The control signal output end is used for outputting the control signal generated by the processor, thereby controlling the drive mechanism so as to control the vehicle speed.

### BACKGROUND OF THE INVENTION

1. Field of the Invention

The present invention generally relates to a control system of a vehicle cruise device, and more particularly to a control system of a vehicle cruise device adaptable to various vehicles.

2. Description of the Related Art

With the enhancement of vehicle performance, various cruise or speed control systems have been provided in the vehicle nowadays to maintain the speed of the vehicle at a predetermined constant. In response to the variations of the road condition, such system automatically regulates the throttle position of a carburetor or an intake manifold so as to maintain the preset vehicle speed.

A conventionally commercial system generally utilizes a vacuum servo modulator disposed between a vacuum storage tank connected to the intake manifold of the engine and a vacuum actuator so as to maintain the traveling speed of the vehicle at a preset value. However, if the road condition violently varies, such cruise control device will not only cause violent variation of the position of the throttle valve and thus reduce the engine efficiency, but also cause the decrease of the vacuum of the intake manifold and further reduce the engine efficiency. The foregoing cruise control or automatic speed control system has been disclosed in U.S. Pat. No. 3,485,316 issued to Slavin et al. on Dec. 23, 1969 entitled “Automobile speed Control” and U.S. Pat. No. 4,170,274 issued to Colonia on Oct. 9, 1979 entitled “The Traveling Speed Of A Motor Vehicle.”

Now, many known vehicle cruise devices include a drive mechanism connected to the throttle linkage of a vehicle by a wire, a command module for operating the device by a driver, and a control system for receiving the driver's command, thereby controlling the drive mechanism so as to control the vehicle speed. Now referring to FIG. 1, it depicts the block diagram of the control system 10 in the prior art. As shown in the drawing, the control system 10 includes a traveling signal input 16 for inputting the vehicle traveling signal into the control system 10, a command input 18 connected to the command module for receiving the control command from a driver, a processor 12 for generating the control signal in response to the control command and the traveling signal, and a control signal output 20 for outputting the control signal generated by the processor 12 and thereby controlling the drive mechanism so as to control the vehicle speed. The control system 10 further includes a dip switch 14 to set the parameters of the control system 10.

For example, a general dip switch of a control system has 5 bits, i.e., it can provide 2⁵=32 available parameters to respectively set pulses per miles (PPM), acceleration pulse at initialization (INIT), overall servo loop gain (Gain), etc. As mentioned above, since the parameters set in the dip switch are finite, the parameters set in the control system cannot exactly match with the parameters of the actual infinite traveling parameters. For instance, the pulses per miles of the control system can just be set as eight predetermined values in the range of from 1000 to 8000 PPM. However, the actual PPM of the vehicle cannot be exactly equal to one of the predetermined values, thus only the value closest to the actual one can be selected. The control system therefore cannot completely match with the vehicle. Due to that, violent variation of the vehicle speed under the cruise mode occurs and further incurs the driver's discomfort and even danger.

Moreover, the dip switch needs to be set in accordance with a variety of vehicle parameters by a technician, the setting process is quite difficult for a common driver. For example, during the setting of the parameter of INIT, the technician must drive the vehicle and set it to a cruise mode. Were there violent variation of the acceleration, the technician must stop and reset the vehicle to achieve the optimal condition. Such setting process is not only difficult but also dangerous.

Accordingly, there exists a need to provide a control system of the vehicle cruise device which is adaptable to and easily matches with various vehicles to control the speed of the vehicle.

### SUMMARY OF THE INVENTION

It is an object of the present invention to provide a control system of the vehicle cruise device which is installed in a vehicle cruise device, and the vehicle cruise device can be installed in various kinds of vehicles and match them.

It is another object of the present invention to provide a control system of the vehicle cruise device, wherein the parameters of the control system can be easily set and even a general driver can complete the setting operation.

In order to achieve the above objects, the present invention provides a control system for a vehicle cruise device which is installed in a vehicle driven by an internal-combustion engine that has a speed control mechanism to control the vehicle speed. The vehicle cruise device includes a drive mechanism controllably connected to the speed control mechanism, a command module to operate the cruise control device by the driver, and the control system for receiving the command from the driver and thereby controlling the drive mechanism so as to control the vehicle speed. The control system includes a traveling signal input end, a command input end, a memory, a processor, and a control signal output end. The traveling signal input end is used for inputting the vehicle traveling signal into the control system. The command input end is connected to the command module for receiving the control command from the driver. The memory is used for storing the setting parameters of the control system. The processor is used for generating a control signal according to the control command, traveling signal, and setting parameters. The control signal output end is used for outputting the control signal generated by the processor, thereby controlling the drive mechanism so as to control the vehicle speed.

According to another aspect of the present invention, the memory is a Non-Volatile Random Access Memory (NVRAM).

According to a further aspect of the present invention, the parameters stored within the memory are those selected form the group consisting of the parameters of pulses per miles (PPM), acceleration pulses at initialization (INIT), over servo loop gain, and the ac/de-celeration pulses transmitted to a servo actuator after completing the acceleration or deceleration function.

According to still another aspect of the present invention, the parameters stored in the memory can be set by the driver via the command module.

According to a still further aspect of the present invention, the control system has a transfer program so that the control system can be applied to various command modules.

The control system of the vehicle cruise device according to the present invention can be installed in a vehicle cruise device, the vehicle cruise device is able to match various kinds of vehicles, and a general driver can easily set the parameters of the control system.

### BRIEF DESCRIPTION OF THE DRAWINGS

The above and other objects, aspects and advantages of the present invention will become apparent from the following description of embodiments with reference to the accompanying drawings.

FIG. 1 is a block diagram of a control system of a vehicle cruise device in prior art.

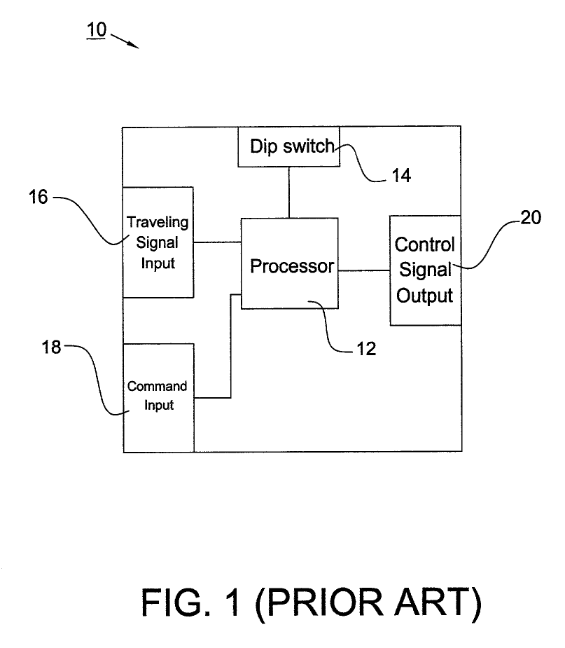

FIG. 2 is a block diagram of a control system of a vehicle cruise device of the preferred embodiment according to the present invention.

### DESCRIPTION OF THE PREFERRED EMBODIMENT

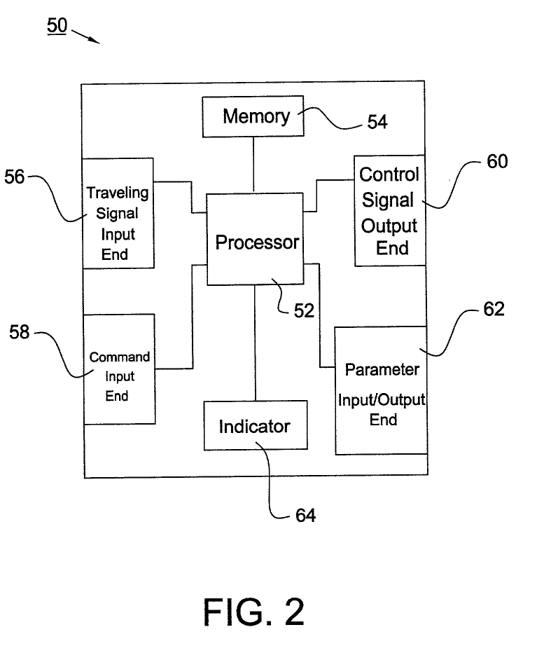

Now referring to FIG. 2, it depicts a block diagram of the control system 50 of a vehicle cruise device according to an embodiment of the present invention. The control system 50 is applied to a vehicle cruise device installed in a vehicle. The vehicle is commonly driven by an internal-combustion engine and the engine has a speed control mechanism to control the vehicle speed. The vehicle cruise device includes a drive mechanism connected to a vehicle throttle linkage by a wire, a command module for operating the cruise device by a driver, and the control system 50 for receiving the driver's command, and thereby controlling the drive mechanism so as to control the vehicle speed.

As shown in FIG. 2, the control system 50 includes a traveling signal input end 56 for inputting a vehicle traveling signal into the control system 50, a command input end 58 connected to the command module for receiving the control command from a driver, a processor 52 for generating a control signal in response to the control command and the traveling signal, and a control signal output end 60 for outputting the control signal generated by the processor 52 and thereby controlling the drive mechanism so as to control the vehicle speed. The control system 50 further includes a memory 54 to store the setting parameters of the control system 50.

Moreover, the control system 50 further includes an indicator 64 to indicate the control system mode, the indicator 64 includes a light emitting diode (LED) and a buzzer. The command module commonly includes three buttons, i.e., an Accelerate/Set button, an On/Off button, and a De-accelerate/Resume button.

The memory 54 is a Non-Volatile Random Access Memory (NVRAM), such as Electrically Erasable Programmable Read-Only Memory (EEPROM) or Flash Memory, and the parameters of the control system 50 of the vehicle cruise device are recorded therein. The parameters will not be lost if the power is shut down and can be modified by a software program.

The memory 54 can store the parameters required by the control system 50 of the cruise control device, such as pulses per miles (PPM), acceleration pulse at initialization (INIT), overall servo loop gain, and the ac/de-celeration pulses transmitted to a servo actuator after completing the acceleration or deceleration function.

To adjust the parameters of the control system 50 of the vehicle cruise device, the driver must set the system into the set mode first. The driver needs to turn the vehicle ignition switch from Off to On and press the brake pedal within one minute, meanwhile quickly press the set button four times in succession to set the system into the set mode. The control system 50 will sound the buzzer of the indicators 64 with four high tone beeps so as to respond to the driver and represent the entry of the set mode.

Afterward, if the driver wants to set the PPM parameter, the driver must press the brake pedal and quickly press the resume button twice in succession at the same time, and the indicator 64 will be sounded with one low tone beep for responding to each pressing of the resume button. Then, the driver releases the brake pedal and the command module, the control system 50 will respond with two high tone beeps so as to indicate that the system 50 enters the PPM parameter setting mode. The driver further drives the vehicle at a predetermined speed, for example, 70 Km/Hr, and presses the set or resume button of the command module, and the control system 50 will automatically set the PPM parameter with the proportion of the pulse inputted by the traveling signal input end 56 to the predetermined speed.

Similarly, the driver can controllably enter the INIT and Gain parameters setting mode by means of the command modules buttons and the brake pedal. After the entry into the INIT parameter setting mode, the driver must drive the car on a level road at a normal speed, and press and hold the set button until the control system 50 of the vehicle cruise device controls the drive mechanism to pull the accelerator pedal away from the driver's foot. The INIT parameter of the control system 50 is hence set. Further, after the entry into the GAIN parameter setting mode, the driver drives the car on a typical road at a predetermined speed and presses the set button to enter the cruise control. Afterwards, each press of the set button increases the GAIN parameter and each press of the resume button decreases the GAIN parameter.

As mentioned above, the parameters of the control system 50 of the vehicle cruise device according to the present invention, such as PPM, INIT, Over Servo Loop Gain, etc., can be set by the driver conveniently and be adjusted to the optimal condition according to the driver's driving habit.

Moreover, the control system 50 of the vehicle cruise device according to the present invention further has a parameter Input/Output end 62. The parameter Input/Output end 62 can be connected to a laptop computer for example through an serial port and a communication software such as Hyper Terminal or Pro Comm, whereby the control system 50 can output the traveling signal inputted by the traveling signal end 56 and the parameters stored in the memory 54 to the laptop computer for displaying. The laptop computer can monitor the Input/Output parameters of the cruise system so as to calculate the optimal parameters of the vehicle and then directly store the calculated optimal parameters into the memory 54 and apply it to the same model of vehicles.

Furthermore, due to that the control system 50 of the vehicle cruise device according to the present invention has the processor 52 and memory 54, the control system 50 can be further matched with various command modules. The conventional cruise device is only suitable for a specific command module and if such command module is changed, the control system must be redesigned to match various command modules. The memory of the control system 50 according to the present invention has a transfer program so that the control system 50 can be applied to various command modules.

Besides, in the prior art, if the cruise device had been set to the cruise mode and the brake pedal then been pressed to quit the cruise mode, the pressing of the resume button can only cause the vehicle to drive at the previous cruise speed. However, the control system 50 of the vehicle cruise device according to the present invention can preset three speeds at which the driver drives most often so that the driver can easily set the control system 50 to drive the vehicle at one of the three speeds.

Although the preferred embodiments of the invention have been disclosed for illustrative purposes, those skilled in the art will appreciate that various modifications, additions and substitutions are possible, without departing from the scope and spirit of the invention as disclosed in the accompanying claims.

What is claimed is:

1. A control system of a vehicle cruise device, the vehicle cruise device being installed in a vehicle driven by an internal-combustion engine that has a speed control mechanism to control the vehicle speed, and the vehicle cruise device including a drive mechanism controllably connected to the speed control mechanism, a command module to operate the cruise control device by a driver, and the control system for receiving the command from the driver and thereby controlling the drive mechanism so as to control the vehicle speed, the control system comprising:
a traveling signal input end for inputting the vehicle traveling signal into the control system;
a command input end connected to the command module for receiving the control command from the driver;
a memory for storing the setting parameters of the control system;
a processor for generating a control signal according to the control command, traveling signal, and setting parameters; and
a control signal output end for outputting the control signal generated by the processor and thereby controlling the drive mechanism so as to control the vehicle speed.

2. The control system of the vehicle cruise device as claimed in claim 1, wherein the memory is a Non-Volatile Random Access Memory (NVRAM).

3. The control system of the vehicle cruise device as claimed in claim 2, wherein the memory is an Electrically Erasable Programmable Read-Only Memory (EEPROM).

4. The control system of the vehicle cruise device as claimed in claim 2, wherein the memory is a Flash Memory.

5. The control system of the vehicle cruise device as claimed in claim 1, wherein the parameters stored within the memory are those selected from the group consisting of the parameters of pulses per miles (PPM), acceleration pulses at initialization (INIT), over servo loop gain, and the ac/de-celeration pulses transmitted to a servo actuator after completing the acceleration or deceleration function.

6. The control system of the vehicle cruise device as claimed in claim 1, wherein the parameters stored within the memory can be set by the driver via the command module.

7. The control system of the vehicle cruise device as claimed in claim 1, wherein the control system can store at least three predetermined speeds.

8. The control system of the vehicle cruise device as claimed in claim 1, wherein the control system has a transfer program so that the control system can be applied to various command modules.

9. The control system of the vehicle cruise device as claimed in claim 1, wherein the control system further includes an indicator to indicate the operating conditions of the control system.

10. The control system of the vehicle cruise device as claimed in claim 9, wherein the indicator includes a Light Emitting Diode (LED).

11. The control system of the cruise control device as claimed in claim 9, wherein the indicator includes a buzzer.
